(19) United States
(12) Patent Application Publication
(10) Pub. No.: US 2019/0034843 A1
(43) Pub. Date: Jan. 31, 2019

(54) MACHINE LEARNING SYSTEM AND METHOD OF GRANT ALLOCATIONS

(71) Applicant: VIKAS MEHROTRA, Woodbury, MN (US)

(72) Inventor: VIKAS MEHROTRA, Woodbury, MN (US)

(21) Appl. No.: 16/044,345

(22) Filed: Jul. 24, 2018

Related U.S. Application Data
(60) Provisional application No. 62/536,961, filed on Jul. 25, 2017.

(51) Int. Cl. G06Q 10/06; G06N 5/04; G06N 99/00

(52) U.S. Cl. CPC G06Q 10/0631; G06F 3/0483; G06N 99/005; G06N 5/04

(57) ABSTRACT

A cloud-based system and method for providing an interactive graphical user interface of a variable population set of applicants to a university for grant allocation are disclosed. The system receives student population data, target data, and historical data from one or more data sources. The received student population data, the historical data, and the target data are processed to create a master database, which includes a plurality of master database parameters. Subsequently, a plurality of scores for each applicant are determined based on various sets of the master database parameters. Based on the master database parameters and target data, threshold levels for grant allocation and success index are determined using a machine learning system. The threshold levels are dynamically changed using new target data to obtain a range of values for grant allocation. A simulation rendering the dynamic change of threshold levels is provided to the user.

### CROSS-REFERENCES TO RELATED APPLICATIONS

The present application claims priority to U.S. Provisional Application No. 62/536,961, filed on Jul. 25, 2017, which is incorporated herein by reference in its entirety.

### FIELD OF THE INVENTION

The invention generally relates to cloud based machine learning systems, and in particular to systems, methods, and devices for customized and dynamically variable grant allocation recommendations.

### DESCRIPTION OF RELATED ART

Educational institutions, such as universities and colleges, rely on various techniques to offer favorable and effective financial assistance to help prospective students enroll. Candidates are typically assessed to determine whether they qualify financially and academically. For example, universities may provide a predetermined scholarship grant to a student based on their academic scores, extra-curricular activities, and motivational assessment as to their academic goals based on a statement of purpose, among other inputs.

The existing and traditional methodologies provide student grant recommendations based on pre-determined criteria. The universities use only a handful of variables to derive grant guidance for students. This may lead to poor allocation of scholarship funds that may indirectly affect quality and quantity of students enrolling. Inaccurate grant allocation may adversely influence student success while concurrently aggravating financial challenges faced by universities. Financial instability is a key reason why many universities lose accreditation or face probation. At the same time, student success rates are questionable. Available data shows that half of an incoming class did not graduate on time and half of that number did not graduate at all. Attainment rates for high school completion are at 87%, whereas for four-year colleges they are at 34%. Each year roughly $30 billion dollars are spent on incoming freshmen classes, which is a rather large sum of money. Yet there is still year over year increase in student debt, increase in student drop-out, and continued increase in tuition fees.

Further, grant award decisions require a complex process, which leads to overfunding or underfunding of students, both of which can be detrimental to the universities and/or students. A lack of understanding of student reaction to an admission offer is due to a limited set of indicators. The applicant pool may generally have a heterogeneous composition—demographically, academically, and financially. Therefore, the applicants may have different needs, demands, and expectations, which may be dynamic in nature, or change even while the admissions process is in progress. This introduces an additional layer of complexity for analysis.

Currently, there exist no technical solutions for providing optimized and individualized grant recommendations for students. The existing methods provide grants based on predetermined or fixed criteria and use only a handful of variables to derive grant guidance for students meeting those criteria. For instance, US20150149379A1 describes systems and methods for student evaluation and enrollment at an institution by determining enrollment probability of the student population in accordance with the student associated variables. However, there is need for a solution that enables dynamic estimation and optimization of the grant allocation process.

### SUMMARY OF THE INVENTION

The present subject matter, in general, relates to, processing multitude of data to understand student enrollment to universities, and in particular, discloses methods and systems for providing an optimized allocation of grants to university applicants through an interactive graphical user interface in a cloud-based machine learning system.

In various embodiments, a method of providing customized and dynamically variable grant allocation recommendations via an interactive graphical user interface (GUI) for access to data relating to a variable population set of applicants to a university is disclosed. The method comprises the steps of receiving, at a cloud server connected to a network, student population data, historical data, and target data from one or more data sources. The student population data may comprise information associated with biographic parameters, the historical data may comprise information associated with historical parameters of the university, and the target data may comprise information associated with target data parameters of the university. The next step involves compiling, by the cloud server, the student population data and the historical data to create a master database, wherein the master database comprises a plurality of master database parameters.

The method, in the next steps involves receiving, at the cloud server, inquiry request data relating to university admissions and determining, by the cloud server, an inquiry score for each inquiry request based on a first set of master database parameters. The inquiry score may indicate a propensity to apply to the university. In a following step, the method involves determining, by the cloud server, an admit score and an admit rank for each applicant based on a second set of master database parameters of each applicant, wherein the admit score indicates a likelihood that the applicant will be accepted by the university. Then, set of applicants are determined for admission based on the admit scores and the admit rank. In a following step, the method involves predicting, by the cloud server, threshold levels for allocation of grants and a success index for each applicant based on at least the target data and a third set of master database parameters. The success index may indicate the likelihood of an applicant enrolling for a grant amount. In a subsequent step, the method involves predicting, by the cloud server, an enrollment score and an enrollment rank based on a fifth set of master database parameters for each of the set of applicants, the enrollment score and the predictive rank indicating a propensity of enrollment.

In the next step, the method involves displaying, via a graphical user interface, a simulation of the grant allocation as a function of target data parameters, wherein the simulation includes a first range of values for allocation of grants for each applicant. Then, the method involves receiving new target data based on an authentication of a user for dynamically changing the grant allocation. In a final step, the method involves displaying, via the graphical user interface, a second range of values for allocation of grants for each of the applicants based on the new target data.

In various embodiments, the target data parameters are selected from the group consisting of total budget, student admission count, student diversity, student quality, university preferences, and goals associated with the university. The historical parameters are selected from the group consisting of past enrollments, grants, student retention, and alumni data. In some embodiments, the biographic parameters are selected from one or more of demographic data, geographic data, inquiry data, marketing data, financial aid data, family history, census data, competition data, social media, third party data, and grant data.

The method in some embodiments further comprises predicting, by the cloud server, that a deposit will be received from an applicant based on the threshold level and a fourth set of master database parameters. In some embodiments the method may further comprise generating a report indicating a status of attainment of the university goals against predetermined benchmarks.

The method in some embodiments further comprises receiving application data associated with an application request after an inquiry request, wherein the application data is selected from data on gender, age, location, educational background, GPA, cut-off scores, sports proficiency level, and past student preferences, and determining an application score for each application request. The method in some embodiments further comprises determining a retention score of each of the set of applicants based on a sixth set of master database parameters, the retention score indicating likelihood of retention of a student.

In various embodiments the method further comprises calculating a total life-term value of the students enrolled in the university based on a seventh set of master database parameters. The method in some embodiments further comprises pre-processing the received student population data, historical data, and the target data, pre-processing comprising one or more of data cleansing, data standardization, and data transformation.

The method in various embodiments further comprises creating a training dataset, a validation dataset, and a test dataset from the master database, and training one or more machine learning models using the training dataset. The method further involves tuning the one or more machine learning models using the validation dataset and evaluating performance of the one or more machine learning models using the test dataset.

In various aspects, the invention discloses a system for providing customized and dynamically variable grant allocation recommendations for a variable population set of applicants to a university. The system may comprise one or more processing units, a memory unit coupled to the one or more processing units, wherein the memory unit comprises a plurality of modules. The plurality of modules may comprise a data preparation module configured to receive student population data, historical data and target data from one or more data sources. The student population data comprises information associated with biographic parameters, the historical data comprises information associated with historical parameters of a university, and the target data comprises information associated with target data parameters of the university. The data preparation module is further configured to pre-process the received student population data, historical data and the target data by eliminating errors and adjusting for missing values, and compile the student population data and historical data to create a master database. The master database may comprise a plurality of master database parameters.

The system further comprises an inquiry assessment module configured to receive inquiry request data relating to university admission, and determine an inquiry score for each inquiry request based on a first set of master database parameters. The inquiry score indicates a propensity to apply to the university. The system further comprises a university acceptance module configured to determine an admit score and admit rank for each applicant based on the inquiry request data and a second set of master database parameters of each applicant. The admit score indicates a likelihood that the applicant will be accepted by the university, and determine a set of applicants for admission based on the admit scores and the admit ranks.

The system further comprises an enrollment module configured to determine an enrollment score and an enrollment rank based on a fifth set of master database parameters for each of the set of applicants, wherein the enrollment score and the enrollment rank indicate a propensity of enrollment. The system further comprises a grant optimization module configured to predict threshold levels for allocation of grants and a success index for each of the set of applicants based on the target data and a third set of master database parameters. The success index indicates the likelihood of an applicant enrolling for a grant amount, receive new target data from a user for dynamically changing the threshold levels based on authentication of the user, and predict a range of values for allocation of grants for each of the set of applicants based on the new target data.

The system further includes a graphical user interface (GUI) configured to render a simulation of the grant allocation as a function of target data parameters on a display of one or more user devices. The simulation may comprise dynamically changing the grant allocation based on user selection.

In some aspects the inquiry assessment module is further configured to receive application data associated with an application request for university admission, and determine an application score for each application request. In some aspects the graphical user interface of the system is further configured to provide a role creation tab, wherein the role creation tab enables a user to control access to one or more of the plurality of modules.

In some aspects the memory unit further comprises an administrator module configured to create a plurality of profiles, wherein each profile provides different levels of access to the modules. In some aspects the memory unit comprises a deposit module configured to predict whether a deposit will be received by an applicant based on the threshold level and a fourth set of master database parameters, and a goal-setting module configured to generate a report indicating a status of attainment of the university's goals against a predetermined benchmark. The memory unit also comprises a retention module configured to determine a retention score of each of the set of applicants based on a sixth set of master database parameters. The retention score may indicate likelihood of retention of a student. The system further includes a life-time value module configured to calculate a total life-time value of the students enrolled in the university based on a seventh set of master database parameters.

In some aspects, the data preparation module is further configured to create a training dataset, a validation dataset, and a test dataset from the master database. In some aspects the graphical user interface is configured to provide a display tab for each module, wherein the display tab provides analysis of data associated with the module. In some aspects the data preparation module is configured to pre-process the data by data cleansing, data standardization, and data transformation.

In various aspects, the one or more data sources is selected from a census reports, competitor analytics and business intelligence reports, web traffic analytics, public database, a university database, an application database, a financial aid databases, and a social media network.

In various aspects, the invention discloses a computer program product having non-volatile memory therein, carrying computer executable instructions stored therein for providing an interactive graphical user interface (GUI) for access to data relating to a variable population set of applicants to a university for custom grant allocation. The instructions may comprise receiving, at a cloud server connected to a network, student population data, historical data, and target data from one or more data sources. The student population data comprises information associated with biographic parameters, the historical data comprises information associated with historical parameters of the university, and the target data comprises information associated with target data parameters of the university. The instructions are further for compiling, by the cloud server, the student population data and the historical data to create a master database, wherein the master database comprises a plurality of master database parameters.

The instructions are further for receiving, at the cloud server, inquiry request data relating to university admission, and determining, by the cloud server, an inquiry score for each inquiry request based on a first set of master database parameters, wherein the inquiry score indicates a propensity to apply to the university. The instructions are further for determining, by the cloud server, an admit score and an admit rank for each applicant based on a second set of master database parameters of each applicant, wherein the admit score indicates a likelihood that the applicant will be accepted by the university. In a next step, the instructions are for determining, by the cloud server, a set of applicants for admission based on the admit scores and the admit rank.

The instructions further cause predicting, by the cloud server, threshold levels for allocation of grants for each of the set of applicants based on at least the target data and a third set of master database, wherein the success index indicates the likelihood of an applicant enrolling for a grant amount. In a subsequent step, the instructions further cause predicting, by the cloud server, an enrollment score and an enrollment rank based on a fifth set of master database parameters for each of the set of applicants, wherein the enrollment score and the predictive rank indicate a propensity of enrollment.

The instructions then cause displaying, via a graphical user interface, a simulation of the grant allocation as a function of target data parameters, the simulation including a first range of values for allocation of grants for each of the set of applicants. The instructions further include receiving, at the cloud server via graphical user interface, new target data for dynamically changing the grant allocation, wherein the new target data is received based on an authentication of a user, and displaying, via the graphical user interface, a second range of values for allocation of grants for each of the set of applicants based on the new target data.

This and other aspects are disclosed herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 illustrates a simplified block diagram network comprising a system for providing optimized allocation of grants, according to an embodiment of the present subject matter.

FIG. 2 illustrates a simplified block diagram of a system for providing optimized allocation of grants to applicants, according to an embodiment of the present subject matter.

FIG. 3 illustrates a simplified block diagram showing the aggregation of data to create a master database, according to an embodiment of the present subject matter.

FIG. 4 illustrates a plurality of sets in the master database, according to an embodiment of the present subject matter.

FIG. 5 illustrates a method for providing optimized allocation of grants, according to an example of the present subject matter.

FIG. 6 is a block diagram representing the method for providing optimized allocation of grants, according to another embodiment of the present subject matter.

FIG. 7 illustrates a user interface displaying success index of an applicant, according to an embodiment of the present subject matter.

FIG. 8 illustrates a user interface displaying a tab for grant optimization module, according to an example of the present subject matter.

FIG. 9 illustrates a user interface displaying a tab for administration module, according to an example of the present subject matter.

FIG. 10 illustrates a method for training the data preparation module, according to an example of the present subject matter.

FIG. 11 illustrates a method for training the inquiry assessment module, according to an example of the present subject matter.

FIG. 12 illustrates a method for training the university acceptance module, according to an embodiment of the present subject matter.

FIG. 13 illustrates a method for training the deposit module, according to an embodiment of the present subject matter.

FIG. 14 illustrates a method for training the enrollment module, according to an embodiment of the present subject matter.

FIG. 15 illustrates a method for training the retention module, according to an embodiment of the present subject matter.

FIG. 16 illustrates a method for training the life-time value module, according to an embodiment of the present subject matter.

FIG. 17 illustrates a method for training the grant optimization module, according to an embodiment of the present subject matter.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

In the following detailed description, references are made to the accompanying drawings that form a part hereof, and that show, by way of illustration, specific embodiments or examples. Although various aspects of the disclosure will be described using with regard to illustrative examples and embodiments, those disclosed embodiments and examples should not be construed as limiting.

The invention in its various embodiments relates to a method, a device and a system for optimally allocating grants to applicants to a university. The system, method and device allow for dynamically controlling and predicting optimal allocation of the grants to shortlisted applicants from a plurality of applicants.

As defined herein, student population data includes all information associated with biographic parameters, such as factual information relating to life, academic, work experiences as well as details associated with ambitions, opinions, behavior, values, etc. Historical data includes all information associated with historical parameters of the university. University refers to any educational institution such as, but not limited to, a public or private university, community college, trade school, junior college, technical college, polytechnic, or the like. Target data includes all information associated with target data parameters of the university such as those reflecting the preferences of the university. The target data parameters may include, but not limited to, total scholarship budget, student volume, student diversity (based on age, gender, location, educational background, work experience, etc.), student quality (based on academics, extra-curricular activities, etc.), other goals of the educational institution.

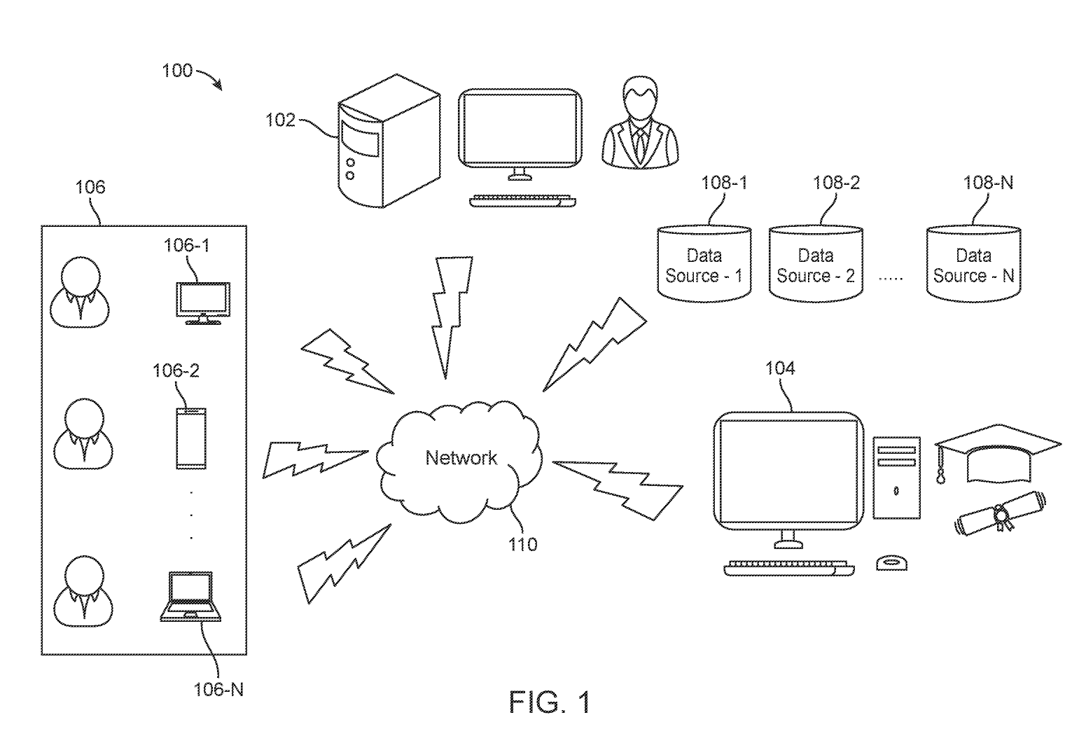

A system network for providing optimal grant allocation to applicants to a university is as illustrated in FIG. 1, according to an embodiment of the present subject matter. The system network 100 provides a cloud based machine learning platform for grant optimization for universities. The system network 100 may primarily include a first system 102, a second system 104 connected to the university, a plurality of applicant devices 106-1, 106-2, . . . , 106-N, and one or more data sources 108-1, 108-2, . . . , 108-N, communicatively coupled over a network 110. The system is configured to distribute data from diverse sources over the network to the remote system. The system 102 aggregates a multitude of data associated with students and universities from diverse data sources 108. The data sources 108 may include data stores including public database, university database, application database, financial aid database, search engine index, social media networks, census, and the like. The system 102 performs machine learning operations, such as predictive analytics, to determine optimal allocation of grants to applicants and/or potential candidates to universities. The universities may communicate with the system 102 through the second system 104.

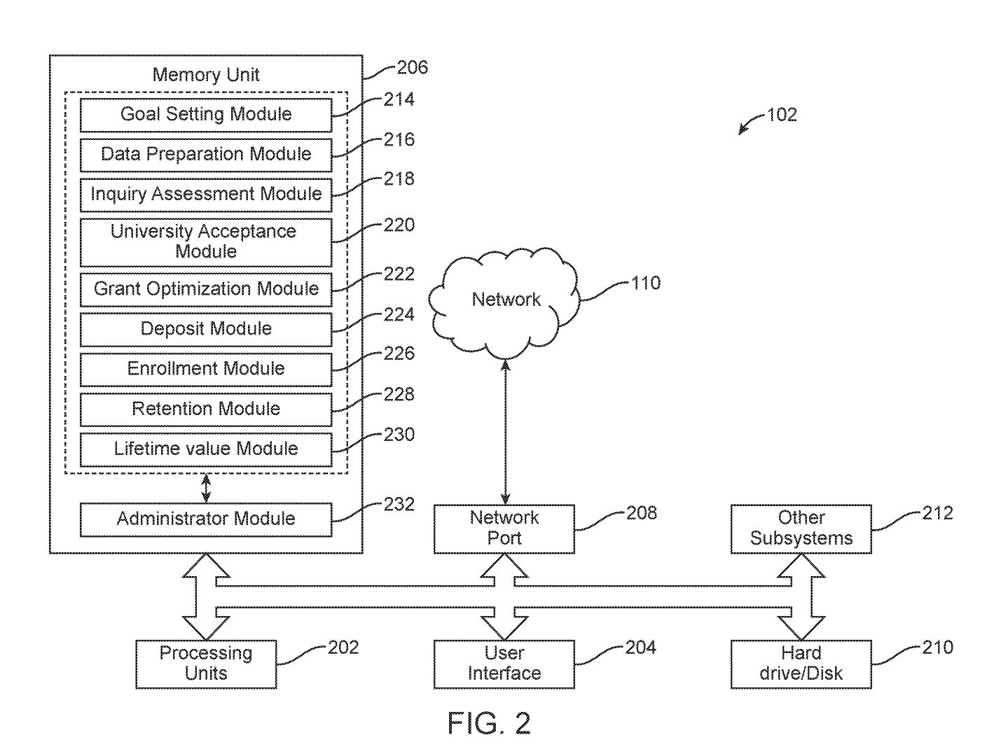

The system 102 is further illustrated using a simplified block diagram in FIG. 2, according to an embodiment of the present subject matter. The system 102 may be a computing system including, but not limited to, one or more processing units 202, user interface 204, memory unit 206, network port 208, hard disk/drive 210, and/or other subsystems 212. The memory unit 206 includes a plurality of modules: a goal setting module 214, a data preparation module 216, an inquiry assessment module 218, a university acceptance module 220, a grant optimization module 222, a deposit module 224, an enrollment module 226, a retention module 228, a life-time value module 230, and/or an administrator module 232. In one embodiment, the modules may be implemented as software code to be executed by the processing unit using any suitable computer language. These software codes may be stored as a series of instructions or commands in the memory unit 206. In various embodiments, the modules may be implemented as one or more software modules, hardware modules, firmware modules, or some combination of these.

In various embodiments, the goal setting module 214 is configured to gauge, record, monitor status, i.e., progress of the goals of the university. The goals of the university may be for example, increase student diversity by 10% year on year, increase student quality by 20%, and the like. The goals may be provided by the second system 104 to the system 102 over the network. In some embodiments, the goal setting module generates a report indicating a status of attainment of the university's goals against a predetermined benchmark. In one embodiment, the goal-setting module generates a periodic report or information on execution and whether they are on track. The capturing of institutional goals provides not only the baselines and benchmarks necessary for effective execution but also as inputs to machine learning modules that drive optimization and improvement in net tuition revenue. In some embodiments, the goal setting modules enable running reports contrasting and informing variances against execution and strategy. In some embodiments, the larger variances are flagged and raised for corrective actions.

In various embodiments, the data preparation module 216 is configured to receive student population data, historical data, and target data from one or more data sources 108. In some embodiments, the student population data includes information associated with biographic parameters. In some embodiments, historical data includes information associated with historical parameters of the university. In some embodiments, the target data includes information associated with target data parameters of the university. In some embodiments, the data preparation module 216 is also configured to pre-process the received student population data, historical data, and the target data by eliminating errors and adjusting for missing values. Further, the data preparation module 216 is configured to analyze the prepared student population data and the historical data to create a master database. The master database includes a plurality of master database parameters and information associated with those parameters as will be discussed later.

In various embodiments, the inquiry assessment module 218 is configured to receive inquiry request data relating to university admission. In some embodiments, the inquiry request may include visiting or downloading a web page or brochure associated with a university, clicking on a university advertisement on a web page, sending e-mail requesting curriculum or course details, web-based interaction with student counsellors, telephonic inquiries, video call inquiries, etc. In some embodiments, the inquiry assessment module 218 is configured to determine an inquiry score for each inquiry request based on a first set of master database. The inquiry score may indicate a propensity of an applicant to apply to the university. The first set of master database parameters may include identification number, year code, city, state, zip, gender, most recent stage, historical stage date, date of inquiry, entrance term, entrance year, band, sport, counselor initials, etc. In some embodiments, the inquiry assessment module is configured to receive application data associated with application requests to the university. The inquiry assessment module may determine an application score indicating the likelihood of a successful selection of the applicant for admission.

In various embodiments, the university acceptance module 220 is configured to determine an admit score and admit rank for each applicant based on the inquiry request data and a second set of master database parameters of each applicant. In some embodiments, the admit score indicates a likelihood that the applicant will be accepted by the university. Based on the admit scores and ranks, the university acceptance module determines a set of applicants for admission. For instance, the set of applicants may comprise the top 500 admit ranks for further processing.

In various embodiments, the grant optimization module 222 is configured to predict threshold levels for allocation of grants and a success index for each determined applicant based on at least the target data and a third set of master database parameters. In some embodiments, the success index indicates likelihood of a candidate enrolling for a particular grant amount.

In various embodiments, the deposit module 224 is configured to predict whether a deposit for the allocated grant amount will be received from the applicant. In some embodiments, a deposit score may be determined based on a fourth set of master database parameters. The deposit score may indicate the likelihood a deposit will be received by the applicant.

In various embodiments, the enrollment module 226 is configured to determine an enrollment score and an enrollment rank based on a fifth set of master database parameters for each of the set of applicants, where the enrollment scores and the ranks indicate a propensity of enrollment. In one embodiment, the enrollment module 226 produces output based on those applicants to whom admission offers were made based on the admit score.

In various embodiments, the retention module 228 is configured to determine a retention score of each of the set of applicants based on a sixth set of master database parameters, where the retention score indicates likelihood of retention of a student. In some embodiments, the life-time value module 230 is configured to calculate a total life-time value of the students enrolled in the university based on a seventh set of master database parameters.

In various embodiments, the grant optimization module 222 is configured to receive new target data to dynamically change the threshold levels for an optimal grant for each determined applicant. A range of values are predicted for optimal grant for each determined applicant based on the new target data.

In various embodiments, the user interface 204 is configured to render a simulation of the grant allocation as a function of target data parameters on a display of the system 102 and 104. The display devices as described herein may refer to any known computing device known in the art such as, but not limited to a laptop, a tablet, a smart phone, and/or a desktop. The simulation includes dynamically changing the grant allocation based on user selection. The administrator module 232 is configured to create a plurality of profiles, wherein each profile provides different levels of access to the modules.

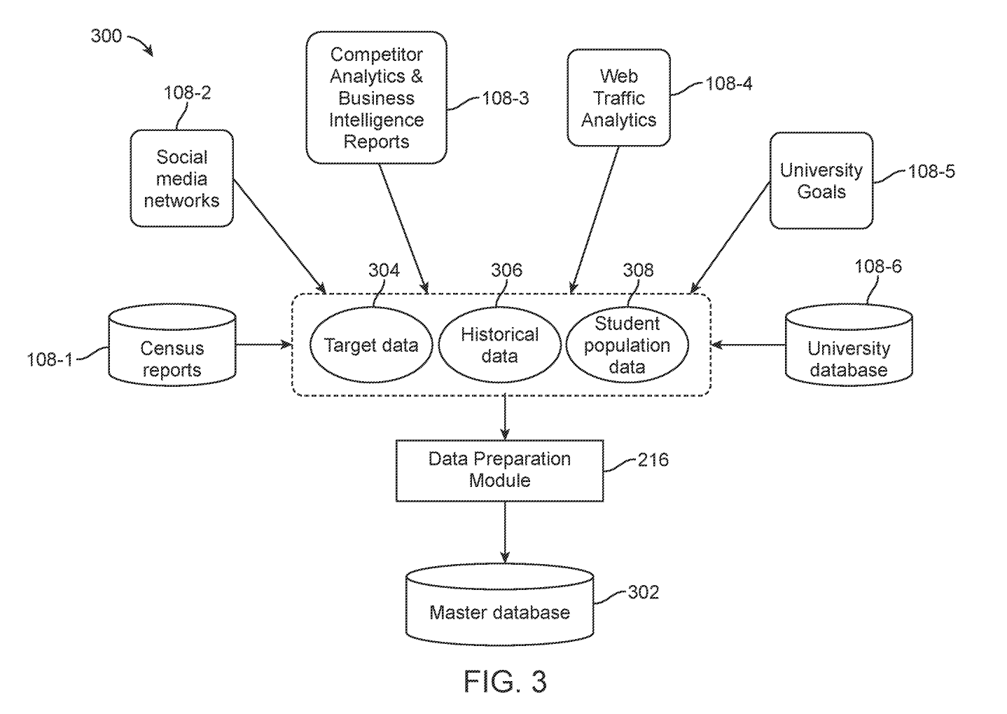

A simplified block diagram to illustrate aggregation of data to create master database is illustrated in FIG. 3, according to one embodiment of the present subject matter. The master database 302 may be created using the target data 304, historical data 306, and student population data 308. The target data 304 includes the information associated with the target data parameters of the university. For example, the target data parameters may include, but not limited to, total budget, student count, student diversity, student quality, university preferences, and other goals associated with the university. The target data may be received from the system 104 or may be provided as an input through user interface 204 of system 102. The historical data 306 includes the information associated with the historical parameters of the university. The historical parameters may include metrics of all students previously associated with the university. Examples of historical parameters may include, but not limited to, past inquiries, past applications, past admissions, past grants, past retention data, past life-time value data, past enrollments, etc., at the university. The student population data 308 may include information associated with biographic parameters of a population of students. Examples of biographical parameters may include, but not limited to, academic score data, such as high school status, graduation details, GPA, SAT, ACT composite scores, TOEFL, etc.; demographic data, such as age, gender, birthdate, city, state, zip code, country, province, citizenship, ethnicity, marital status, etc.; financial information, such as family income, parents' highest education, parents' citizenship, parents' marital status, family size, number of college students from family, family total assets, family net worth, student's income, student's total assets, guardian's income, siblings employment, siblings alma mater, etc.; and other information, such as desired housing option, religious views, interest in athletic programs, interest in extra-curricular activities, etc. The data may be extracted and/or aggregated from census reports 108-1, social media networks 108-2, competitor analytics and business intelligence reports 108-3, search engine index or web traffic analytics 108-4, university databases 108-6, and the like. In one embodiment, the historical data 306 is aggregated from the university database 108-6.

The aggregated data is provided to the data preparation module 216 for data preparation. In various embodiments, the data preparation step may include data weighting, data balancing, and/or data filtering, to eliminate sample bias in the received data. Further, data preparation may also include dimensionality reduction to reduce number of random variables under consideration by obtaining a set of principal variables. Additionally, data discretization may also be employed to convert large number of data values into smaller numbers to simplify data evaluation and data management. In some embodiments, data derivation may be performed to create new data variables or parameters from one or more contributing data values. The prepared data may be analyzed to create the master database 302.

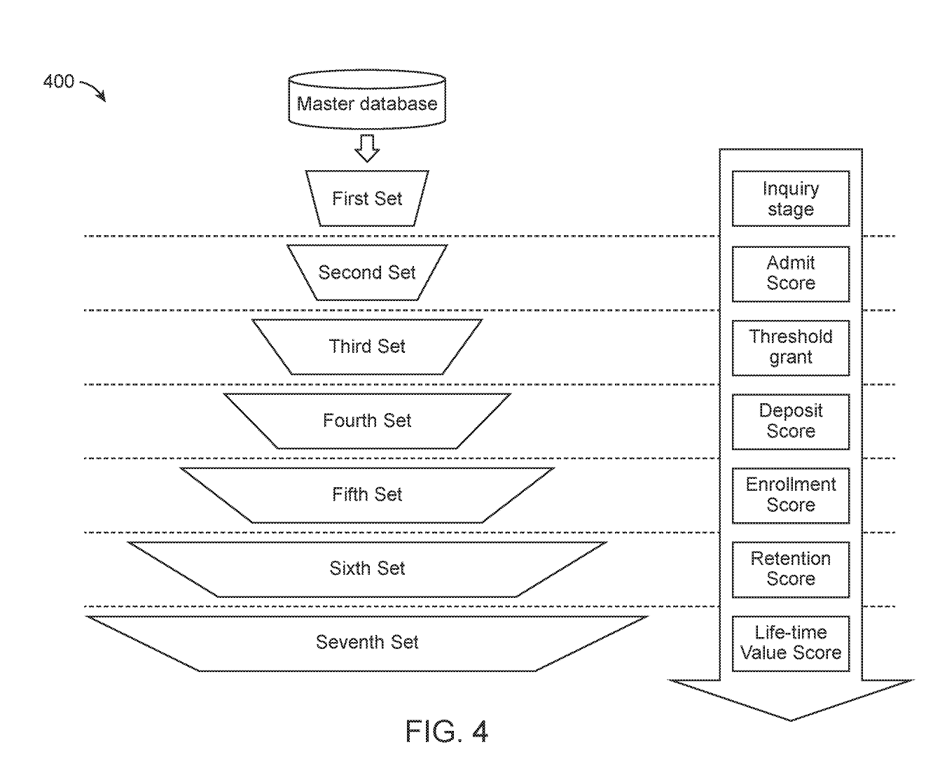

In various embodiments, the master database 302 may include data that are aggregated into a plurality of sets, which may be used as inputs for the different modules. In various embodiments, the cardinal number of parameters in the sets may be in an ascending order from the first set to the seventh set of master database parameters, as shown in FIG. 4. The first set of parameters may be used assessing admission-related inquiries as well as applications of the university applicants. The second set may be used for determining admit scores and ranks. The third set may be used for determining a threshold grant allocation and success index. The fourth set may be used for predicting deposit receipt. The fifth set may be used for enrollment score and rank. The sixth set may be used for retention score. The seventh set may be used for life-time value. In one embodiment, the first set of parameters may be a subset of second set of parameters, the second set of parameters may be a subset of third set of parameters, and so on.

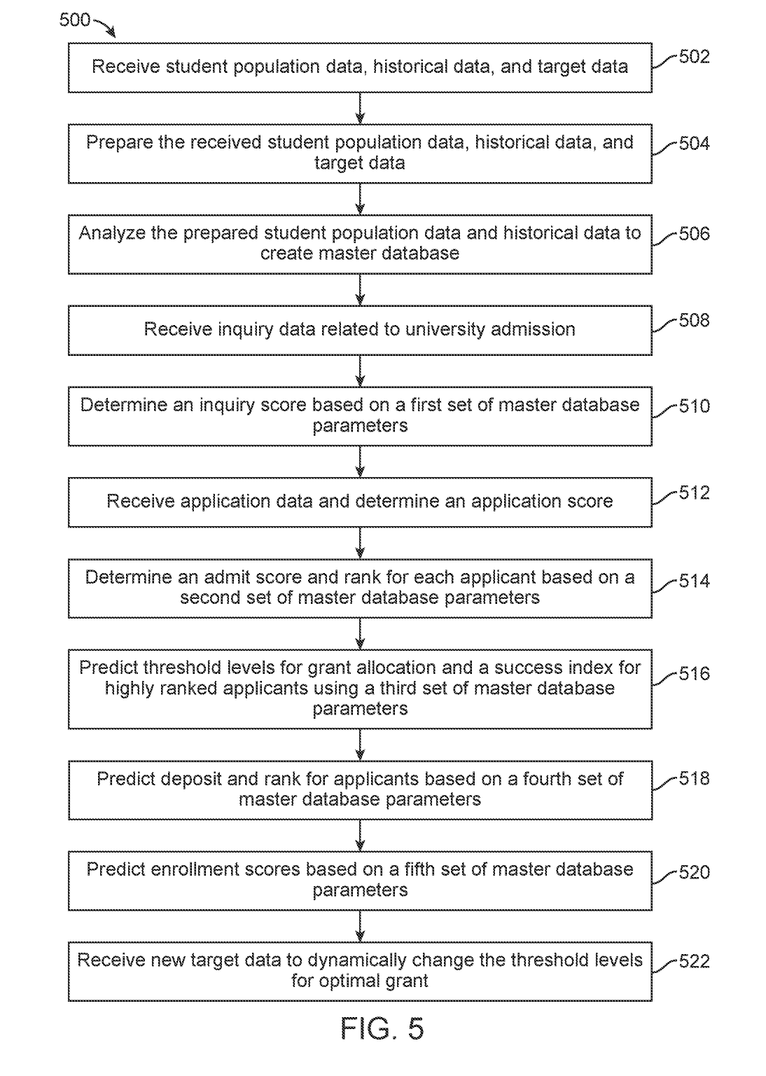

A flow diagram illustrating a method 500 for allocating grants to applicants to university is shown in FIG. 5, according to an embodiment of the present subject matter. The method includes receiving student population data, target data, and historical data from one or more data sources by one or more processing units of the system 102, at block 502. The received student population data, the historical data, and the target data are prepared by eliminating errors and adjusting for missing values, at block 504. The prepared student population data and the historical data are analyzed to create a master database, at block 506. The master database includes a plurality of master database parameters. Inquiry request data relating to university admission are received, at block 508. An inquiry score is determined for each inquiry request based on a first set of master database parameters, at block 510. The inquiry score indicates a propensity to apply to the university. Application data associated with an application request is received and a corresponding application score is determined, at block 512. An admit score and an admit rank for each applicant is determined based on at least a second set of master database parameters, at block 514. The admit score indicates a likelihood that the applicant will be accepted by the university. A set of applicants for admission based on the admit scores are determined. Further, threshold levels for allocation of grants and a success index are predicted for each applicant based on at least the target data and a third set of master database parameters, at block 516. Based on the determined threshold level and a fifth set of master database parameters, it is predicted whether a deposit will be received from an applicant for admission, at block 518. Further, an enrollment score and a predictive rank are determined based on a fifth set of master database parameters for each of the set of applicants, at block 520. The enrollment scores and the predictive ranks indicate a propensity of enrollment. On receiving a new target data, via the user interface, the threshold levels are dynamically changed for an optimal grant for each determined applicant, at block 522. The dynamic change in the threshold levels may involve using the received new target data to predict new threshold levels as performed in step 516. Based on the threshold levels, a range of values for allocation of grants are obtained. In some embodiments, the new target data from block 522 is used as input in any of the previous blocks for allocating grants to applicants of university. In an exemplary embodiment, the new target data is used as input for the next admission cycle and/or following an administrator's override instructions.

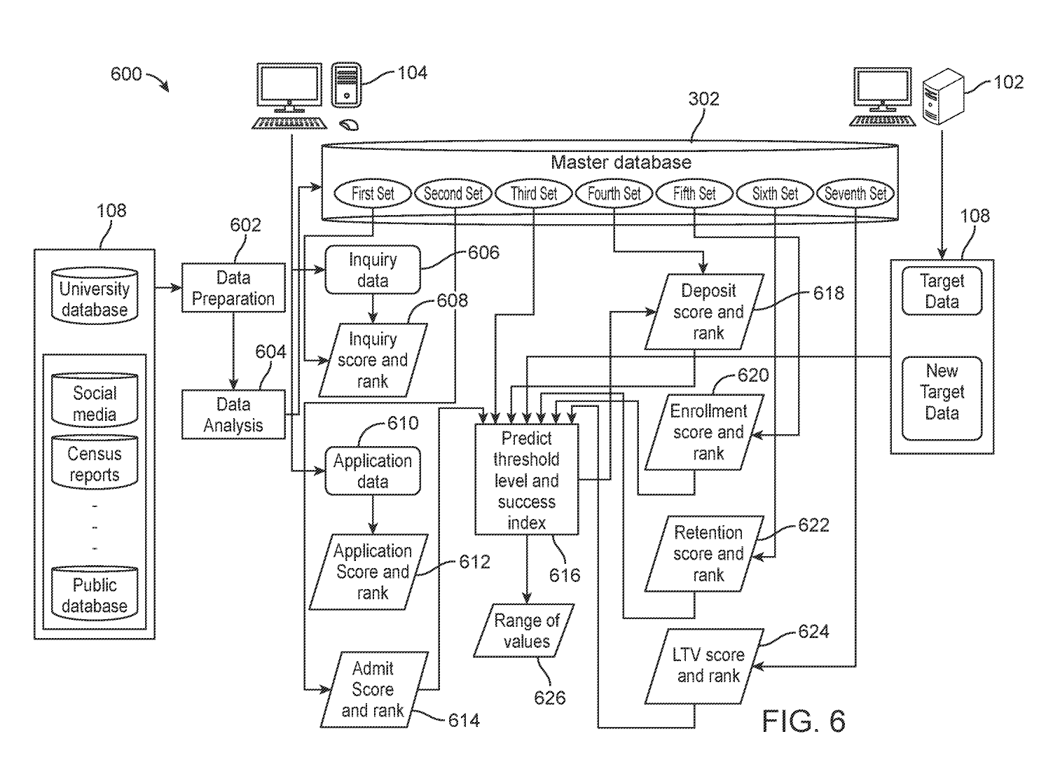

A simplified block diagram representative of the method 500 is illustrated in FIG. 6, according to one embodiment of the present subject matter. The block diagram illustrates preparing the historical and student population data at 602 received from data sources 108. In some embodiments, the data preparation step is automated as will be discussed later. The automation of the data preparation reduces the time consuming, costly and error prone aspect of the data modeling exercise by aggregating the right data from multiple data sources and adjusting for missing value and outliers. The prepared data is analyzed at 604 to create the master database 302, which includes the plurality of sets of the master database parameters. The master database 302 may be used for recognizing patterns and relationships, building models for problem analysis, identifying opportunity areas. In some embodiments, the master database may be stored in a separate remote data store that can be accessed through network. The university system 104 receives a number of inquiry requests from potential applicants. The inquiry data associated with the inquiry requests is received at 606. In some embodiments, the inquiry data may be matched with the master database to determine an identity of the applicant. Based on the identification, a plurality of associated data variables is retrieved from the master database to perform further computations. In one embodiment, a first set of master database parameters of the identified student may be used for determining an inquiry score and/or inquiry rank at 608. Based on the inquiry score and ranks, prospective applicants who would apply to the university may be predicted. For example, if 30,000 inquiry requests are received, it may be determined that 10,000 of the inquiry requests are likely to convert into applications. In some examples, the inquiry score may be indicative of the quality of the inquiry made, i.e., whether the inquiry was a formal, comprehensive, brief, or casual.

The university system 104 may receive applications for enrolling at the university. The received applications at 610 may include application data that may be used to determine an application score and/or rank at 612. In some embodiments, the application score may be determined based on application data and the first set of master database parameters. The application scores may indicate the likelihood of the application being shortlisted by the university. In some examples, the application score may indicate the quality of the application request, i.e., whether the application is complete, has DC code, or includes UST rejections, etc. Further, an admit score and/or rank is determined at 614 using the second set of master database parameters. The admit score and rank indicate the likelihood an applicant will be accepted at the university. In some embodiments, the university system 104 may communicate with system 102 to specify a threshold rank for selection of a set of applicants. Using the third set of master database parameters and target data, a threshold level and a success index is determined at 616 for each applicant. The threshold level indicates a particular grant amount for which the candidate may enroll at the university and the success index indicates the possibility of the applicant enrolling at the university for different grant amounts. The threshold levels and the success index may be optimized further using additional processing of the data.

For instance, a deposit score and/or rank may be predicted using a fourth set of master database parameters at 618. The deposit score and/or rank may indicate the likelihood an applicant may submit deposit if or when accepted to the university. Further, enrollment score and/or rank is determined at 620 based on a fifth set of master database parameters. The enrollment score may indicate the likelihood the applicant may enroll at the university. Similarly, a retention score and/or rank, and a LTV score and/or rank are determined based on the sixth and seventh set of master database parameters at 622 and 624, respectively. The retention score may indicate the likelihood the retention of the applicant at the university on course completion and the life-time value may indicate the net value the university can obtain from the enrollment of the student.

In some embodiments, the deposit score, enrollment score, retention score, and LTV score may be further used for optimizing the threshold level and success index. In various embodiments, the system 102 may receive new target data through the user interface or from the university system 104. The grant amount and the success index allocated may be changed dynamically based on new values of the target data. A user may obtain a simulation of the change in success index based on the change in target data through the user interface. In some embodiments, the system may receive additional data associated with a student, such as a feedback, that may also be used for dynamically changing the success index. A range of values for obtaining a successful enrollment with optimized allocation may be obtained based on the dynamic change.

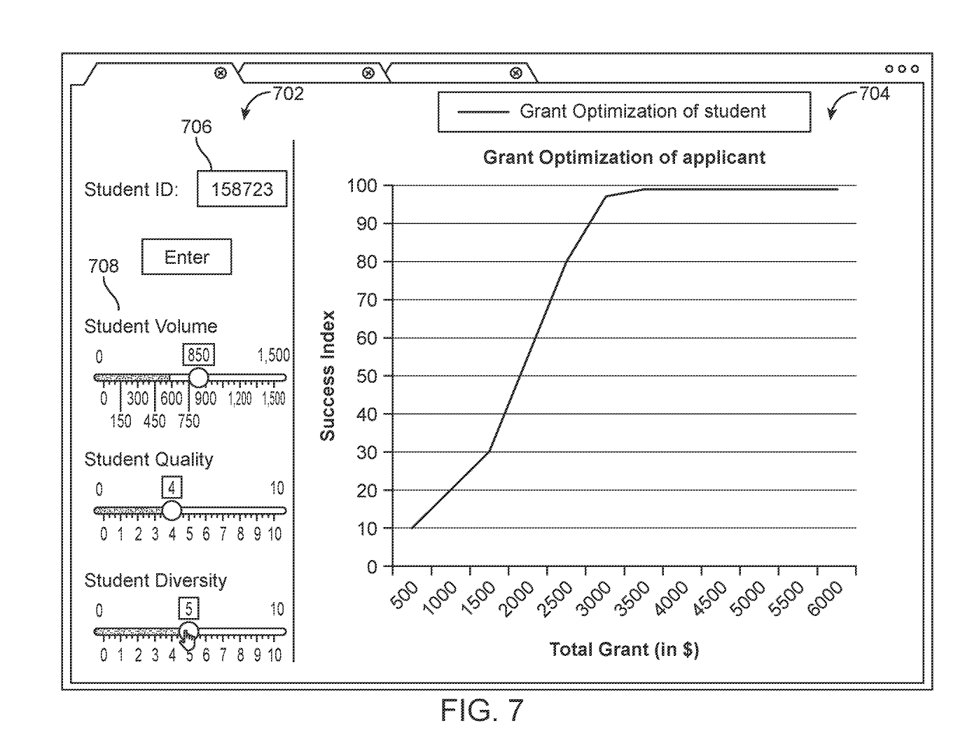

A user interface providing a representative graph showing the total grant vis-à-vis the success index along with options to change the target data is illustrated in FIG. 7. The user interface may include a control panel 702 and an output panel 704. The control panel 702 provides options to enter an identifier, such as a student ID at 706 and a corresponding success index graph is displayed in the output panel 704. The target data may be adjusted at 708 to provide new target data values as desired by the user. In one exemplary embodiment, the student volume, quality and/or diversity may be adjusted over a custom scale ranging from low to high, as shown in FIG. 7. For instance, the target data parameters may be tweaked by sliding the scores for student volume, student quality, and student diversity. The student volume score, which ranges from 0-1500, may indicate the number of students the university targets to enroll. The student quality score may indicate a normalized score, ranging from 1-10, based on parameters, such as academics, extra-curricular activities, examinations scores, etc. Similarly, the student diversity score may indicate a normalized score based on parameters, such as age, gender, location, educational background, etc. The normalized score of “10” may result in student selection with greater diversity and quality, while “0” may result in selection of students with lesser diversity or poorer academic credentials.

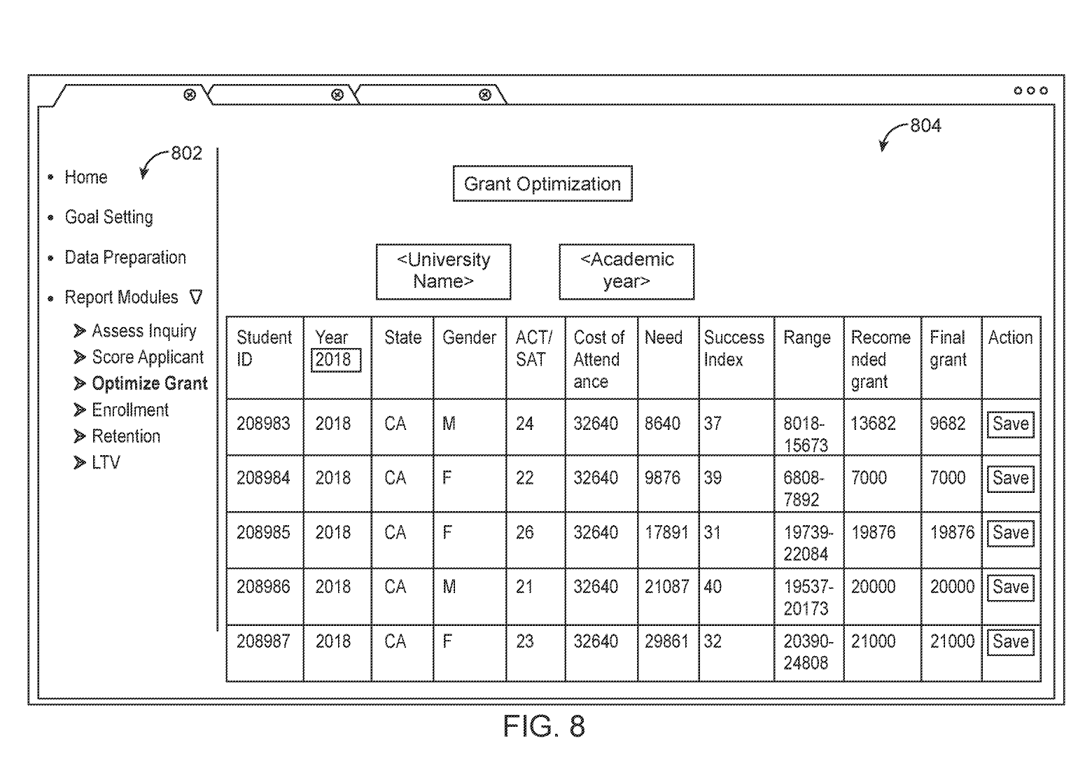

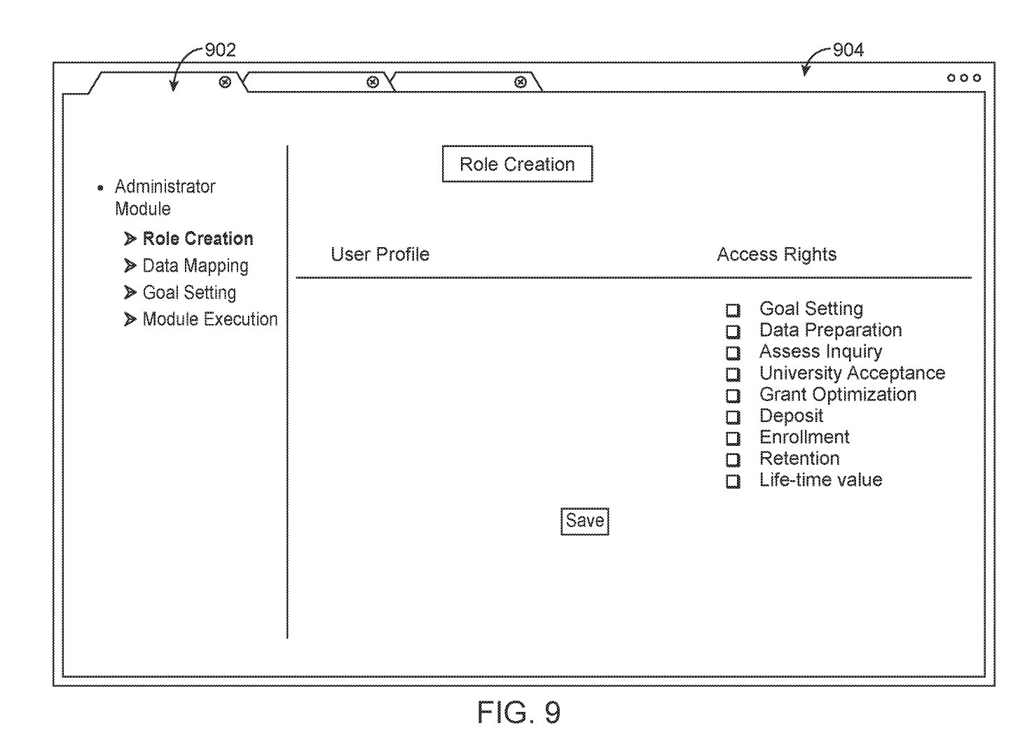

Similarly, in other embodiments, the user interface provides tabs providing detailed analysis of each module, for example interface for grant optimization module is shown in FIG. 8. A control panel 802 may provide a plurality of options for user action. On selecting “Grant Optimization”, the output panel 804 displays details associated with the grant optimization. User interface for an administrator module as shown in FIG. 9 illustrates a control panel 902 and the output panel 904. The control panel 902 provides plurality of options, such as role creation, data mapping, goal setting, and module execution. The output panel 904 displays a role creation tab on selecting “role creation” on the control panel 902. The user can select a profile and control the access rights available to that profile. Further, the administrator module enables the user to select data mapping to upload data received from various data sources for data preparation and analysis. The user may also modify goals of the university using the goal setting option before initiating module execution.

Further, the system may be configured to automatically perform one or more steps for determining an optimal grant allocation to applicants, in various embodiments. For instance, the modules of the system may be trained and fine-tuned to perform one or more of data preparation, inquiry assessment, university acceptance of student, grant optimization, enrollment, etc. Machine learning techniques may be implemented in the plurality of modules. In some embodiments, the plurality of modules may be machine learning algorithms, such as linear regression, logistic regression, decision trees, support vector machine, naïve Bayes, k-nearest neighbors, random forest, etc.

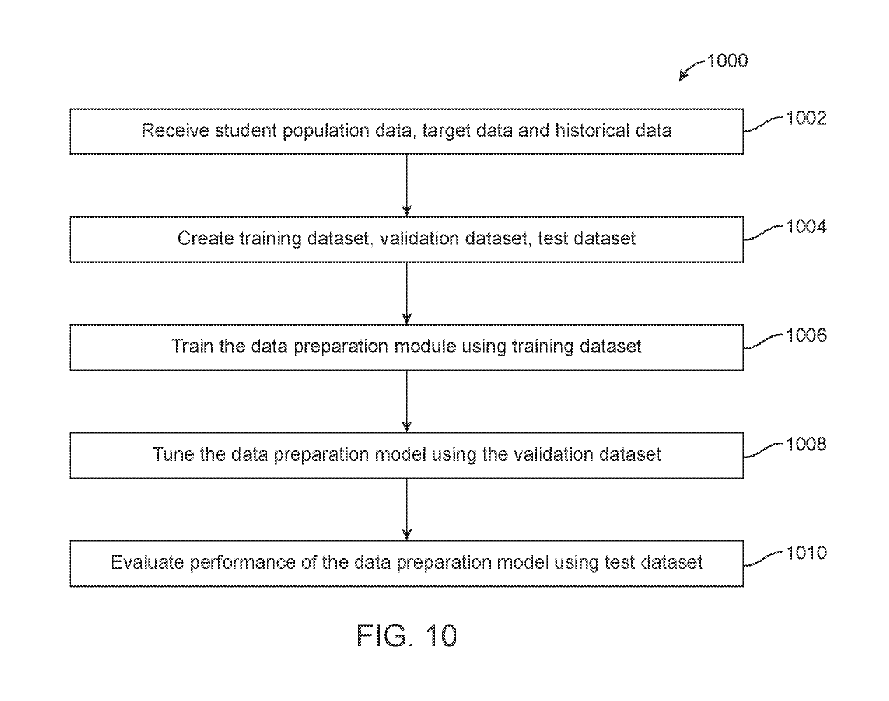

A flow diagram illustrating a method for training the data preparation module is shown in FIG. 10, according to one embodiment of the present subject matter. The method includes receiving student population data, the target data, and the historical data from one or more data sources, at block 1002. The received data is segregated into a training dataset, a validation dataset, and a test dataset at block 1004. In one embodiment, the training dataset may encompass 70% of the received data, the validation dataset may include 15% of the received data, and the test dataset may encompass 15% of the received data. The segregation may be performed randomly or according to a timestamp associated with the data. For instance, the older data may be apportioned to the training dataset and the relatively newer data may be apportioned to the validation and test datasets. The data preparation module is trained using the training dataset as input to develop a data preparation model, at block 1006. The data preparation module performs the various steps of data preparation—data cleansing, data cleansing, data standardization—on the training dataset. The validation dataset is provided as input to the data preparation model for fine tuning, at block 1008. The testing dataset is provided as input to the fine-tuned data preparation model to evaluate the performance of the model, at block 1010. The prepared data is analyzed to create the master database, which is segregated to create a plurality of sets.

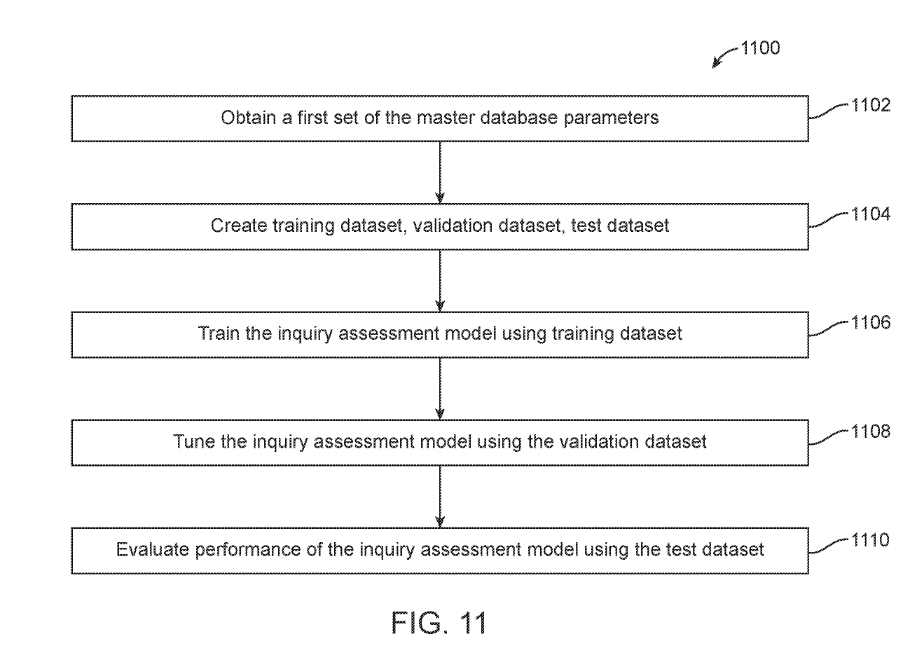

A flow diagram illustrating method for training the inquiry assessment module is shown in FIG. 11, according to one embodiment of the present subject matter. The method includes obtaining a first set of master database parameters from the master database at block 1102. Creating a training dataset, validation dataset, and a test dataset from the first set of master database parameters at block 1104. The training dataset is provided as input to the inquiry assessment module at block 1106. The inquiry assessment module determines inquiry scores on the received training dataset and develops a model. The validation dataset is provided as input to fine tune the inquiry assessment model at block 1108. The test dataset is provided as input to the inquiry assessment model to evaluate the performance of the model at block 1110.

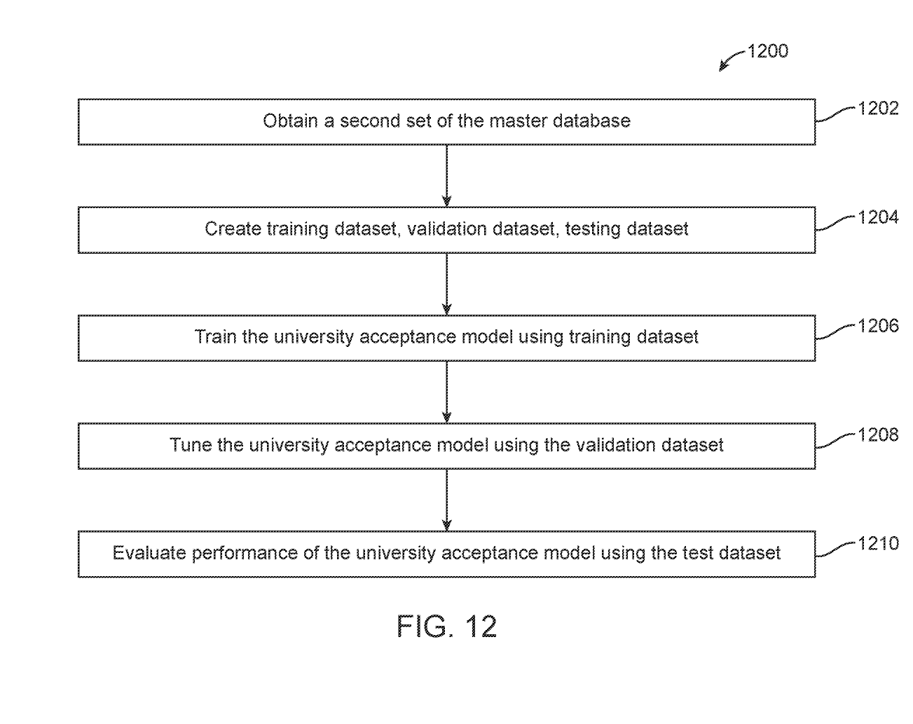

A flow diagram illustrating method for training the university acceptance module is shown in FIG. 12, according to one embodiment of the present subject matter. The method includes obtaining a second set of master database parameters from the master database at block 1202. Creating a training dataset, validation dataset, and a test dataset from the second set of master database parameters at block 1204. The training dataset is provided as input to the university acceptance module at block 1206. The university acceptance module determines admit scores on the received training dataset and develops a model. The validation dataset is provided as input to fine tune the university acceptance model at block 1208. The test dataset is provided as input to the university acceptance model to evaluate the performance of the model at block 1210.

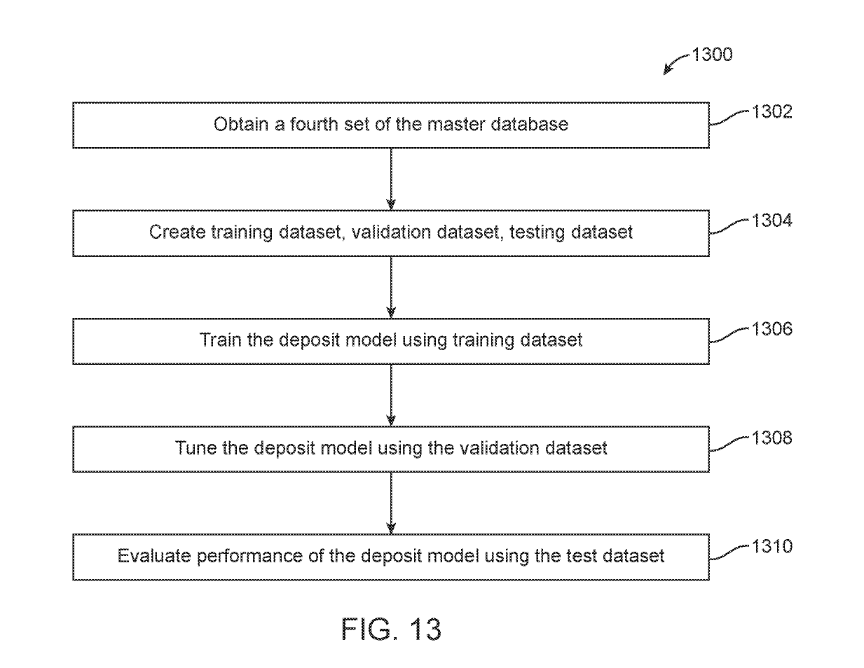

A flow diagram illustrating method for training the deposit module is shown in FIG. 13, according to one embodiment of the present subject matter. The method includes obtaining a fourth set of master database parameters from the master database at block 1302. Creating a training dataset, validation dataset, and a test dataset from the fourth set of master database parameters at block 1304. The training dataset is provided as input to the deposit module at block 1306. The deposit module predicts whether the admitted student will make a deposit for a given threshold grant amount based on the received training dataset and develops a model. The validation dataset is provided as input to fine tune the deposit model at block 1310. The test dataset is provided as input to the deposit model to evaluate the performance of the model at block 1310.

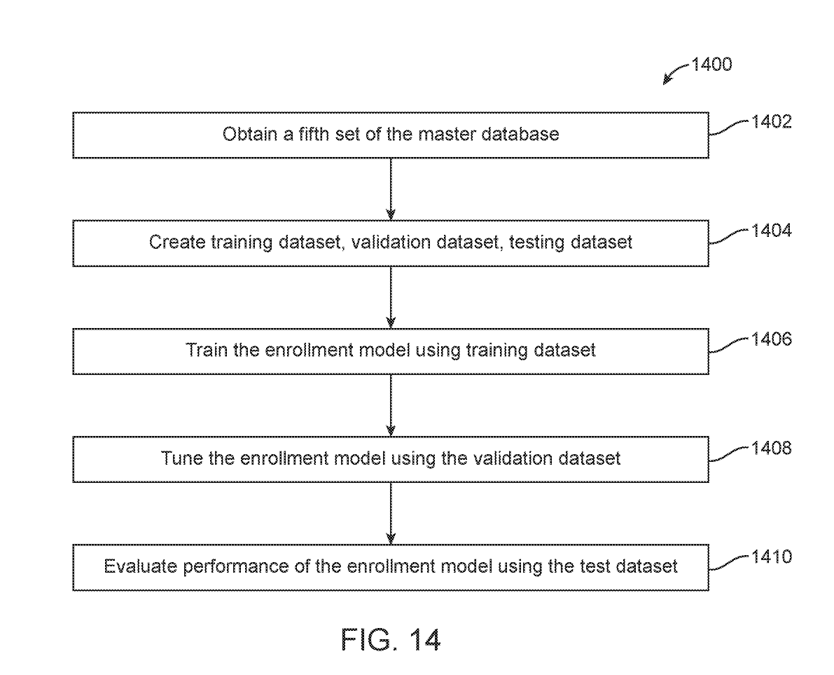

A flow diagram illustrating method for training the enrollment module is shown in FIG. 14, according to one embodiment of the present subject matter. The method includes obtaining a fifth set of master database parameters from the master database at block 1402. Creating a training dataset, validation dataset, and a test dataset from the fifth set of master database parameters at block 1404. The training dataset is provided as input to the enrollment module at block 1406. The enrollment module determines an enrollment score and rank on the received training dataset and develops a model. The validation dataset is provided as input to fine tune the enrollment model at block 1408. The test dataset is provided as input to the enrollment model to evaluate the performance of the model at block 1410.

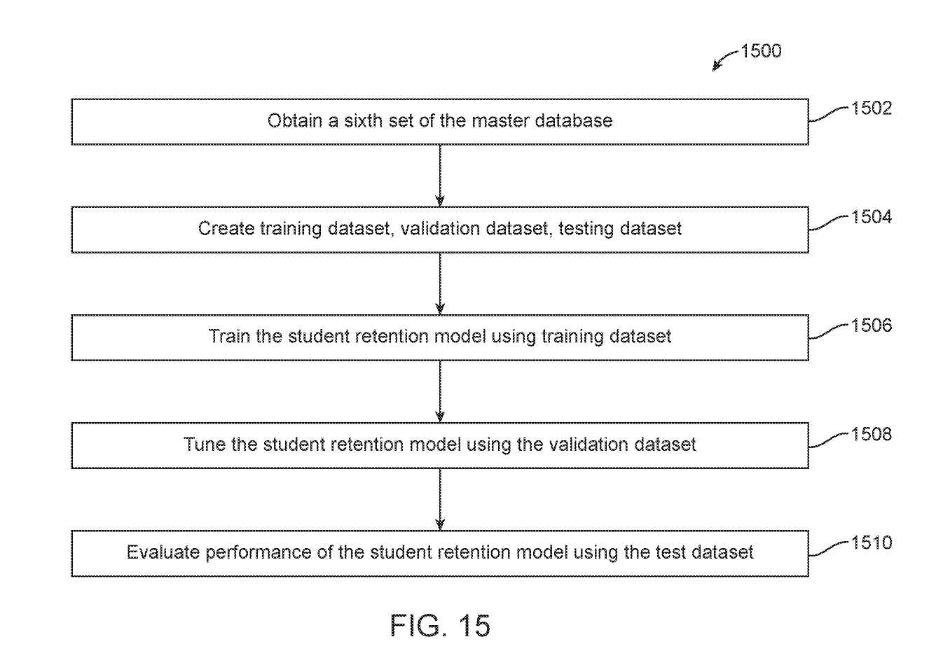

A flow diagram illustrating method for training the retention module is shown in FIG. 15, according to one embodiment of the present subject matter. The method includes obtaining a sixth set of master database parameters from the master database at block 1502. Creating a training dataset, validation dataset, and a test dataset from the sixth set of master database parameters at block 1504. The training dataset is provided as input to the retention module at block 1506. The retention module determines a retention score and rank on the received training dataset and develops a model. The validation dataset is provided as input to fine tune the retention model at block 1508. The test dataset is provided as input to the retention model to evaluate the performance of the model at block 1510.

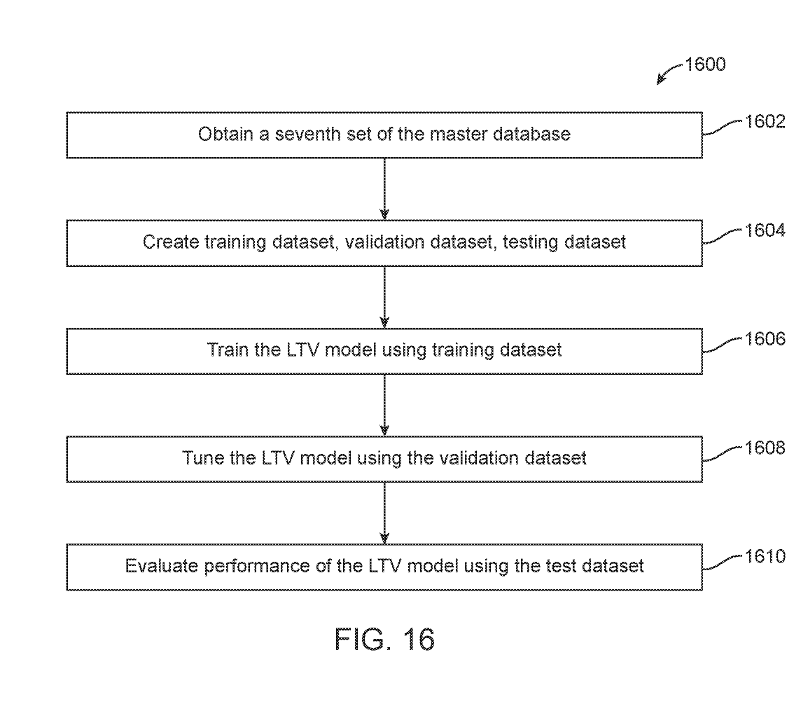

A flow diagram illustrating method for training the life-time value module is shown in FIG. 16, according to one embodiment of the present subject matter. The method includes obtaining a seventh set of master database parameters from the master database at block 1602. Creating a training dataset, validation dataset, and a test dataset from the sixth set of master database parameters at block 1604. The training dataset is provided as input to the life-time value module at block 1606. The life-time value module determines a LTV score and rank on the received training dataset and develops a model. The validation dataset is provided as input to fine tune the LTV model at block 1608. The test dataset is provided as input to the LTV model to evaluate the performance of the model at block 1610.

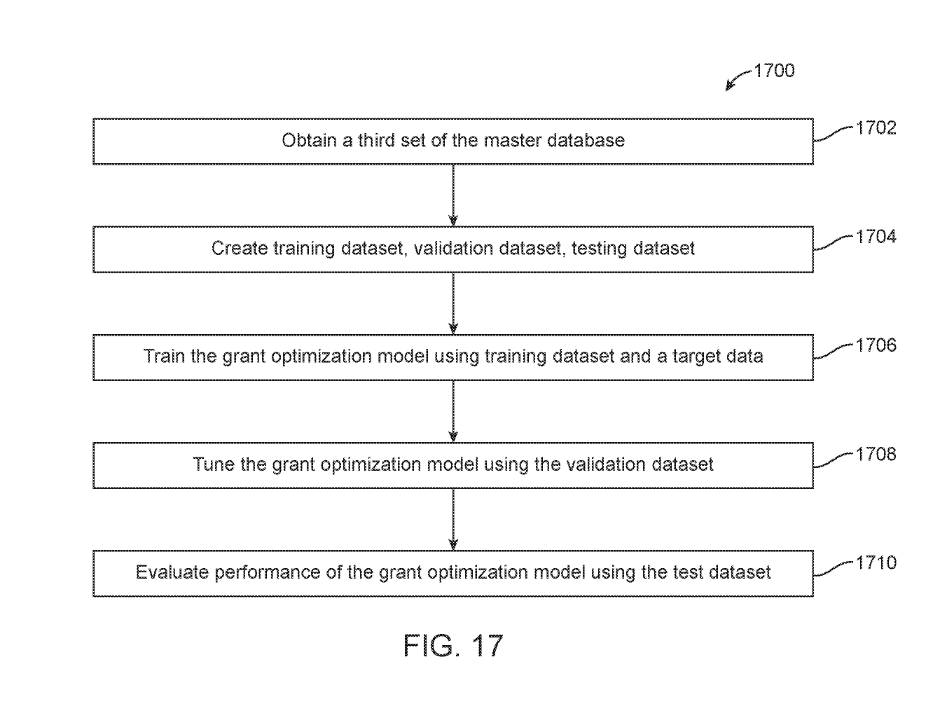

A flow diagram illustrating method for training the grant optimization module is shown in FIG. 17, according to one embodiment of the present subject matter. The method includes obtaining a third set of master database parameters from the master database at block 1702. Creating a training dataset, validation dataset, and a test dataset from the third set of master database parameters and target data at block 1704. The training dataset is provided as input to the grant optimization module at block 1706. The grant optimization module determines a threshold level for grant allocation and a success index on the received training dataset and develops a model. The validation dataset is provided as input to fine tune the grant optimization model at block 1708. The test dataset is provided as input to the grant optimization model to evaluate the performance of the model at block 1710.

The above subject matter and its embodiments provide method and system to allocate grants to applicants to a university. The present subject matter provides an optimal allocation of grants by processing and analyzing large amount of data. The system processes the large datasets and provides accurate prediction of student acceptance, withdrawal, enrollment, and optimal grant allocation. The data processing driven approach enables understanding and estimating student reaction to grant offer, thereby improving student and institution fit. Further, the present subject matter provides a platform for communicating with multiple parties for dynamically receiving and processing data. A real-time output for grant allocation is provided over the platform.

Although the detailed description contains many specifics, these should not be construed as limiting the scope of the invention but merely as illustrating different examples and aspects of the invention. It should be appreciated that the scope of the invention includes other embodiments not discussed herein. Various other modifications, changes and variations which will be apparent to those skilled in the art may be made in the arrangement, operation and details of the system and method of the present invention disclosed herein without departing from the spirit and scope of the invention as described here.

While the invention has been disclosed with reference to certain embodiments, it will be understood by those skilled in the art that various changes may be made and equivalents may be substituted without departing from the scope of the invention. In addition, many modifications may be made to adapt to a particular situation or material the teachings of the invention without departing from its scope.

What is claimed is:

1. A method of providing customized and dynamically variable grant allocation recommendations via an interactive graphical user interface (GUI) for access to data relating to a variable population set of applicants to a university, the method comprising the steps of:
receiving, at a cloud server connected to a network, student population data, historical data, and target data from one or more data sources, wherein the student population data comprises information associated with biographic parameters, the historical data comprises information associated with historical parameters of the university, and the target data comprises information associated with target data parameters of the university;
compiling, by the cloud server, the student population data and the historical data to create a master database, wherein the master database comprises a plurality of master database parameters;
receiving, at the cloud server, inquiry request data relating to university admission;
determining, by the cloud server, an inquiry score for each inquiry request based on a first set of master database parameters, wherein the inquiry score indicates a propensity to apply to the university;
determining, by the cloud server, an admit score and an admit rank for each applicant based on a second set of master database parameters of each applicant, wherein the admit score indicates a likelihood that the applicant will be accepted by the university;
determining, by the cloud server, a set of applicants for admission based on the admit scores and the admit rank;
predicting, by the cloud server, threshold levels for allocation of grants and a success index for each of the set of applicants based on at least the target data and a third set of master database parameters, wherein the success index indicates the likelihood of an applicant enrolling for a grant amount;
predicting, by the cloud server, an enrollment score and an enrollment rank based on a fifth set of master database parameters for each of the set of applicants, wherein the enrollment score and the predictive rank indicate a propensity of enrollment;
displaying, via a graphical user interface, a simulation of the grant allocation as a function of target data parameters, wherein the simulation includes a first range of values for allocation of grants for each applicant;
receiving, at the cloud server via graphical user interface, new target data for dynamically changing the grant allocation, wherein the new target data is received based on an authentication of a user; and
displaying, via the graphical user interface, a second range of values for allocation of grants for each of the applicants based on the new target data.

2. The method of claim 1, wherein:
the target data parameters are selected from the group consisting of total budget, student admission count, student diversity, student quality, university preferences, and goals associated with the university;
the historical parameters are selected from the group consisting of past enrollments, grants, student retention, and alumni data; and
the biographic parameters are selected from one or more of demographic data, geographic data, inquiry data, marketing data, financial aid data, family history data, census data, competition data, social media data, third party data, and grant data.

3. The method of claim 1, further comprising predicting, by the cloud server, that a deposit will be received from an applicant based on the threshold level and a fourth set of master database parameters.

4. The method of claim 1, further comprising generating a report indicating a status of attainment of the university goals against predetermined benchmarks.

5. The method of claim 1, further comprising: receiving application data associated with an application request after an inquiry request, wherein the application data includes information on gender, age, location, educational background, GPA, cut-off scores, sports proficiency level, and past student preferences; and determining an application score for each application request.

6. The method of claim 1, further comprising: determining a retention score of each of the set of applicants based on a sixth set of master database parameters, wherein the retention score indicates likelihood of retention of a student.

7. The method of claim 1, further comprising: calculating a total life-term value of the students enrolled in the university based on a seventh set of master database parameters.

8. The method of claim 1, further comprising: pre-processing the received student population data, historical data, and the target data, wherein pre-processing comprises at least data cleansing, data standardization, and data transformation.

9. The method of claim 1, further comprising:
creating a training dataset, a validation dataset, and a test dataset from the master database;
training one or more machine learning models using the training dataset;
tuning the one or more machine learning models using the validation dataset; and
evaluating performance of the one or more machine learning models using the test dataset.

10. A system for providing customized and dynamically variable grant allocation recommendations for a variable population set of applicants to a university, the system comprising:
one or more processing units;
a memory unit coupled to the one or more processing units, wherein the memory unit comprises a plurality of modules, the plurality of modules comprising:
a data preparation module configured to: receive student population data, historical data and target data from one or more data sources, wherein the student population data comprises information associated with biographic parameters, the historical data comprises information associated with historical parameters of a university, and the target data comprises information associated with target data parameters of the university; pre-process the received student population data, historical data and the target data by eliminating errors and adjusting for missing values; and compile the student population data and historical data to create a master database, wherein the master database comprises a plurality of master database parameters;
an inquiry assessment module configured to: receive inquiry request data relating to university admission; determine an inquiry score for each inquiry request based on a first set of master database parameters, wherein the inquiry score indicates a propensity to apply to the university;
a university acceptance module configured to: determine an admit score and admit rank for each applicant based on the inquiry request data and a second set of master database parameters of each applicant, wherein the admit score indicates a likelihood that the applicant will be accepted by the university; and determine a set of applicants for admission based on the admit scores and the admit ranks;
an enrollment module configured to: determine an enrollment score and an enrollment rank based on a fifth set of master database parameters for each of the set of applicants, wherein the enrollment score and the enrollment rank indicate a propensity of enrollment;
a grant optimization module configured to: predict threshold levels for allocation of grants and a success index for each of the set of applicants based on the target data and a third set of master database parameters, wherein the success index indicates the likelihood of an applicant enrolling for a grant amount; receive new target data from a user for dynamically changing the threshold levels based on authentication of the user; and predict a range of values for allocation of grants for each of the set of applicants based on the new target data; and
a graphical user interface (GUI) configured to render a simulation of the grant allocation as a function of target data parameters on a display of one or more user devices, wherein the simulation comprises dynamically changing the grant allocation based on user selection.

11. The system of claim 10, wherein the inquiry assessment module is further configured to:
receive application data associated with an application request for university admission; and
determine an application score for each application request.

12. The system of claim 10, wherein the graphical user interface is further configured to provide a role creation tab, wherein the role creation tab enables a user to control access to one or more of the plurality of modules.

13. The system of claim 10, wherein the memory unit further comprises:
an administrator module configured to create a plurality of profiles, wherein each profile provides different levels of access to the modules;
a deposit module configured to predict whether a deposit will be received by an applicant based on the threshold level and a fourth set of master database parameters;
a goal-setting module configured to generate a report indicating a status of attainment of the university's goals against a predetermined benchmark;
a retention module configured to determine a retention score of each of the set of applicants based on a sixth set of master database parameters, wherein the retention score indicates likelihood of retention of a student; and
a life-time value module configured to calculate a total life-time value of the students enrolled in the university based on a seventh set of master database parameters.

14. The system of claim 10, wherein the data preparation module is further configured to create a training dataset, a validation dataset, and a test dataset from the master database.

15. The system of claim 10, wherein the graphical user interface is configured to provide a display tab for each module, and wherein the display tab includes analysis of data associated with the module.

16. The system of claim 10, wherein the data preparation module is configured to pre-process the data by data cleansing, data standardization, and data transformation.

17. The system of claim 10, wherein the one or more data sources is selected from a census reports, competitor analytics and business intelligence reports, web traffic analytics, public database, a university database, an application database, a financial aid databases, and a social media network.

18. A computer program product having non-volatile memory therein, carrying computer executable instructions stored thereon for providing an interactive graphical user interface (GUI) for access to data relating to a variable population set of applicants to a university for custom grant allocation, the instructions comprising:
receiving, at a cloud server connected to a network, student population data, historical data, and target data from one or more data sources, wherein the student population data comprises information associated with biographic parameters, the historical data comprises information associated with historical parameters of the university, and the target data comprises information associated with target data parameters of the university;
compiling, by the cloud server, the student population data and the historical data to create a master database, wherein the master database comprises a plurality of master database parameters;
receiving, at the cloud server, inquiry request data relating to university admission;
determining, by the cloud server, an inquiry score for each inquiry request based on a first set of master database parameters, wherein the inquiry score indicates a propensity to apply for the university;
determining, by the cloud server, an admit score and an admit rank for each applicant based on a second set of master database parameters of each applicant, wherein the admit score indicates a likelihood that the applicant will be accepted by the university;
determining, by the cloud server, a set of applicants for admission based on the admit scores and the admit rank;
predicting, by the cloud server, threshold levels for allocation of grants for each of the set of applicants based on the target data and a third set of master database, wherein the success index indicates the likelihood of an applicant enrolling for a grant amount;
predicting, by the cloud server, an enrollment score and an enrollment rank based on a fifth set of master database parameters for each of the set of applicants, wherein the enrollment score and the predictive rank indicate a propensity of enrollment;
displaying, via a graphical user interface, a simulation of the grant allocation as a function of target data parameters, wherein the simulation includes a first range of values for allocation of grants for each of the set of applicants;
receiving, at the cloud server via graphical user interface, new target data for dynamically changing the grant allocation, wherein the new target data is received based on an authentication of a user; and
displaying, via the graphical user interface, a second range of values for allocation of grants for each of the set of applicants based on the new target data.
